(19) United States
(12) Patent Application Publication
(10) Pub. No.: US 2013/0194556 A1
(43) Pub. Date: Aug. 1, 2013

(54) Polarization Conversion System for a PICO-Projector

(71) Applicant: Citizen Finetech Miyota Co., LTD, Miyota (JP)

(72) Inventors: Wanli CHI, Longmont, CO (US); Michael J. O'Callaghan, Louisville, CO (US)

(73) Assignee: Citizen Finetech Miyota Co., LTD, Miyota (JP)

(21) Appl. No.: 13/756,225

(22) Filed: Jan. 31, 2013

Related U.S. Application Data
(60) Provisional application No. 61/593,708, filed on Feb. 1, 2012.

(51) Int. Cl. G02B 27/28; G03B 21/14

(52) U.S. Cl. CPC G02B 27/285; G03B 21/14
USPC 353/121; 362/19

(57) ABSTRACT

An illumination system for a pico-projector that provides polarization conversion includes the combination of an optical element with a series of stacked, elongated PBSs, where alternate ones of the PBSs have a half-wave plate film applied to a back side thereof and a retarder stack film (RSF) that flips or passes different linear polarization orientations based on the wavelength of light. This combination is placed at a position in the illumination system where the impinging light is collimated to at least some degree.

### STATEMENT OF RELATED CASES

This application claims priority under 35 U.S.C. §§119(e) and 120 to U.S. Provisional Patent Application Ser. No. 61/593,708 filed on Feb. 1, 2012 and entitled “Polarization Conversion System for a Pico-Projector”, all of which is incorporated herein by reference.

### BACKGROUND

The combination of solid-state light sources, like light-emitting diodes (LEDs) and lasers, with microdisplays like liquid-crystal-on-silicon (LCOS) devices is leading to the development of electronic projectors small enough to be embedded in, for example, the handset of a mobile phone. In such “pico-projectors,” small optical engine size and high optical efficiency are especially important. Achieving size and efficiency goals requires new ways of combining the light from light sources of different color and creating a polarized beam of light suitable for illuminating a microdisplay panel.

LEDs are widely used in projectors due to their low cost and good power efficiency compared to alternatives. However, LEDs generally emit unpolarized light, whereas polarized light is need for use with liquid crystal displays. In their simplest embodiments, projector architectures simply discard the unusable polarization state which at least halves their efficiency and the brightness of the projected image. In order to raise power efficiency (a key metric for portable consumer products), means of fully converting an LED's unpolarized light into polarized light are needed. Optical systems that perform this function are known as polarization conversion systems (PCS).

It is against this background that the polarization conversion system for a pico-projector has been developed.

### BRIEF DESCRIPTION OF THE DRAWINGS

FIG. 1 is a block diagram for a pico-projector.

FIG. 2a is an illustration of an image of the LED array that is formed at plane 4 in FIG. 1.

FIG. 2b is an illustration of an image of the LED array that is formed downstream of an optical element of FIG. 1.

FIGS. 3a and 3b are illustrations of the optical element of FIG. 1.

FIG. 4 is an illustration showing how the optical element works with the Retarder Stack Filter (RSF) of FIG. 1.

FIG. 5 is a magnified view of a portion of the optical element and RSF of FIG. 4.

### DETAILED DESCRIPTION

While the embodiments of the present invention are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims.

Described herein is a new PCS design that is particularly well suited to pico-projectors having a single-channel illumination architecture (to minimize size and cost), and which contain side-by-side red, green, and blue LEDs whose light passes through a common optical system. The invention takes advantage of a design characteristic of single-channel pico-projectors (inefficient use of the optical system's etendue), together with a specialized optical film for color-selective modifications of the light's polarization state. Unlike some other PCS approaches, this design does not require halving the LEDs areas to compensate for the fact that their &endues are doubled by the PCS optics (which would lower LED power conversion efficiency). Furthermore, it does not increase the overall size of the pico-projector (another key pica-projector metric) and increases the uniformity of light across the projected image.

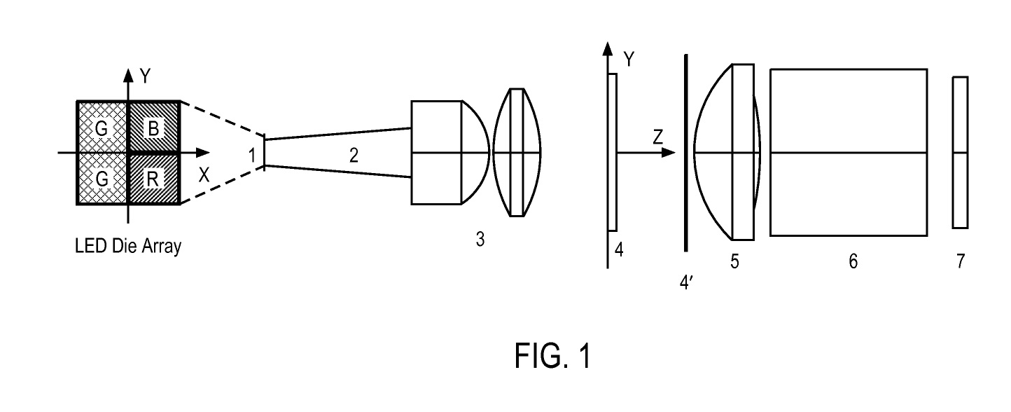

FIG. 1 illustrates a single-channel projector illumination subsystem. A set of RGB LEDs are located at position 1. As can be seen in the illustration of the LEDs to the left of position 1, the LEDs are arranged in a 2×2 array (with two rows and two columns), with one row having a green LED next to a blue LED, and the second row having a green LED next to a red LED. While the LEDs illustrated here are square, they could also be of other shapes. For example, they could be rectangular with a 2:1 aspect ratio. In such case, two such rectangular LEDs could fill a square input aperture for the optical system. It is also possible that the input aperture for the optical system could be rectangular or some other shape than square.

The light from the LEDs passes through a light pipe 2 whose cross-sectional size increases as the distance from the LED array increases. The light pipe 2 serves to create multiple images of the LED array. Further, because of the shape of this light pipe 2, it also serves to partially collimate the light from the LED array. The light is then expanded and further collimated by lenses 3. Other shapes of light pipes (such as, by way of one non-limiting example, a light pipe of constant cross-sectional size) could also be used as could other combinations of light pipes and lenses. Any other arrangement that creates multiple images of the LED array and at least partially collimates the light from the LED array could also be used.

After this, the light passes through optical elements 4 and 4′ which are discussed in much greater detail below, and then through a lens 5 and a polarizing beamsplitter (PBS) 6 before reaching a microdisplay panel 7 (which may include any type of LCD display). For case of reference herein, the term “downstream” is used to indicate a direction toward the panel 7 and “upstream” is used to indicate a direction toward the position 1. While various optical elements such as light sources, collimators, and lenses have been described herein, the techniques for polarization conversion disclosed herein can be achieved with different combinations of optical elements as well.

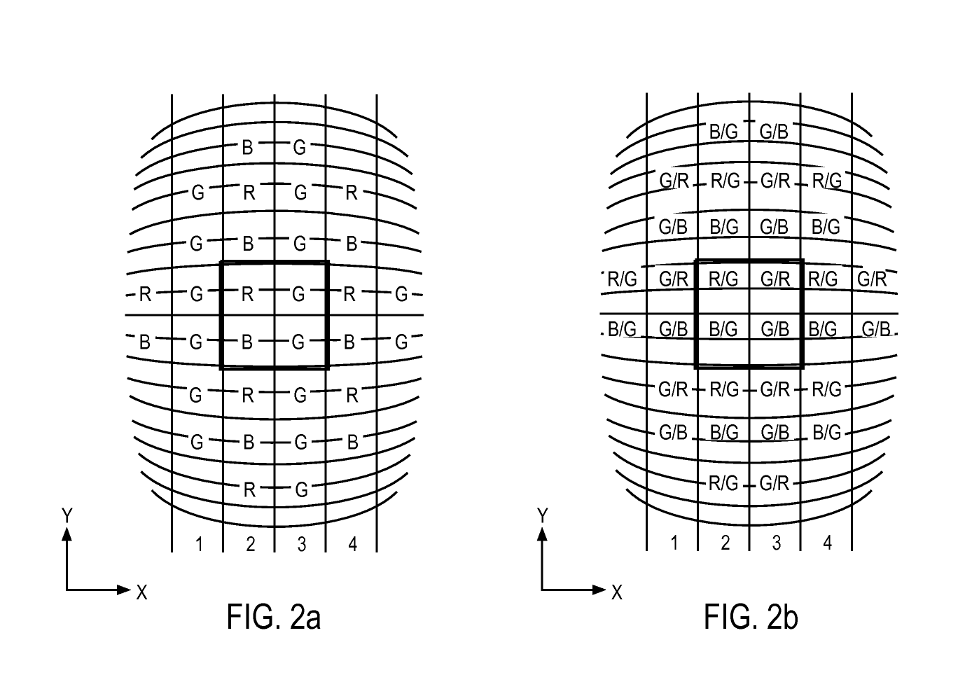

Repeated subimages of the RGB LED array (as shown FIG. 2a) are formed as an image at plane 4 by the light pipe and lenses. Portions of the image are divided into four vertically-oriented columns. As can be seen, columns 1 and 3 have only green subimages, while columns 2 and 4 have subimages that alternate between blue and red. At the center of the image is shown a 2×2 array of subimages that has a first row with a red subimage next to a green subimage and a second row with a blue subimage next to a green subimage. Looking at the rows of the image shows that the subimages alternate as one goes across the row from red to green to red to green, etc., and in the adjacent row from blue to green to blue to green, etc. When referring to rows or columns of the LED array or the image formed at plane 4 or by the optical element 20, the word “line” may be used to generically refer to either a row, a column, or any other straight line therein, such as a diagonal line. Further, while reference is made herein to a 2×2 array, it should be understood that other sizes of arrays could also be used.

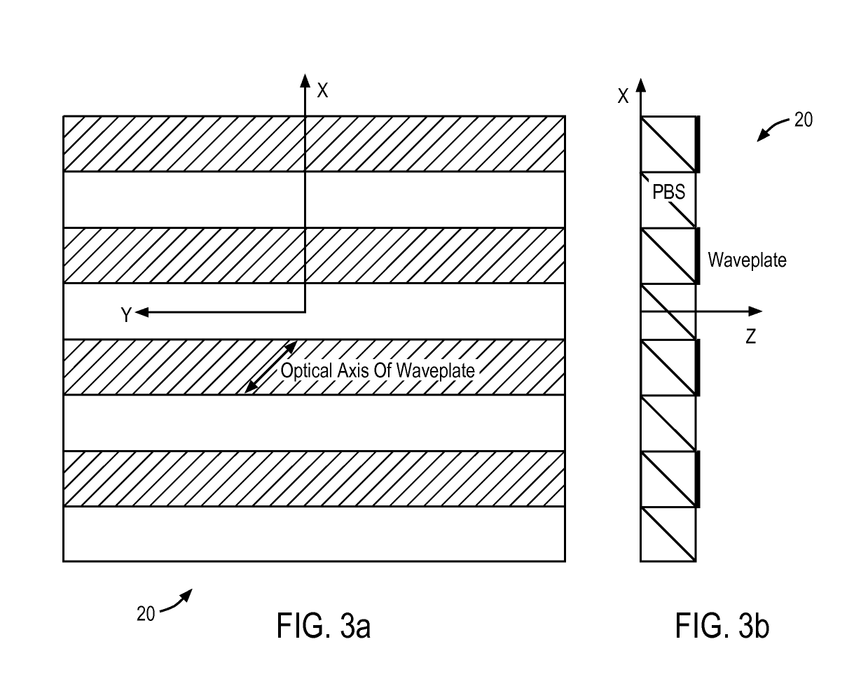

The optical element 20 located at plane 4 includes a PBS array with half wave plate film selectively applied thereto, and is shown in more detail in FIG. 3. It is positioned at plane 4 for polarization conversion. After the optical element 20, the image shown in FIG. 2b is produced. As can be seen, the area of each color is doubled, but the increased area of one color overlaps subimages of another color. For example, in FIG. 2b, RIG means that before the optical element 20 the color of the subimage (FIG. 2a) at this location is red, and after the optical element 20 the color at this location is an overlay (e.g., a superposition) of red and green. Similarly, BIG, G/R, and GIB show the color at this location in FIG. 2a as well as the overlay of colors at this location in FIG. 2b. Note that the total light area of the image after the optical element 20 is the same as that of the original repeated subimages before the optical element 20.

Further detail about the optical element 20 can be appreciated in FIGS. 3a and 3b. FIG. 3a shows that the element includes a series of columns of elongated polarizing beamsplitters. While the drawing may make it appear as if these are stacks of beamsplitter cubes, they actually are elongated, stripe-like structures. Although they appear to be rows instead of columns of beamsplitters, note that the X and Y axes in FIG. 3a are rotated from the orientation shown in FIGS. 2a and 2b. Alternate columns of the beamsplitters have a film applied to the back side thereof to act as a half-wave plate. As shown in FIG. 3a, the half-wave plate has an optical axis that is approximately 45 degrees from each of the X and Y axes. As is well known, a half-wave plate with such an optical axis will take linearly polarized light of a given orientation that is 45 degrees different from the optical axis and rotate it by 90 degrees.

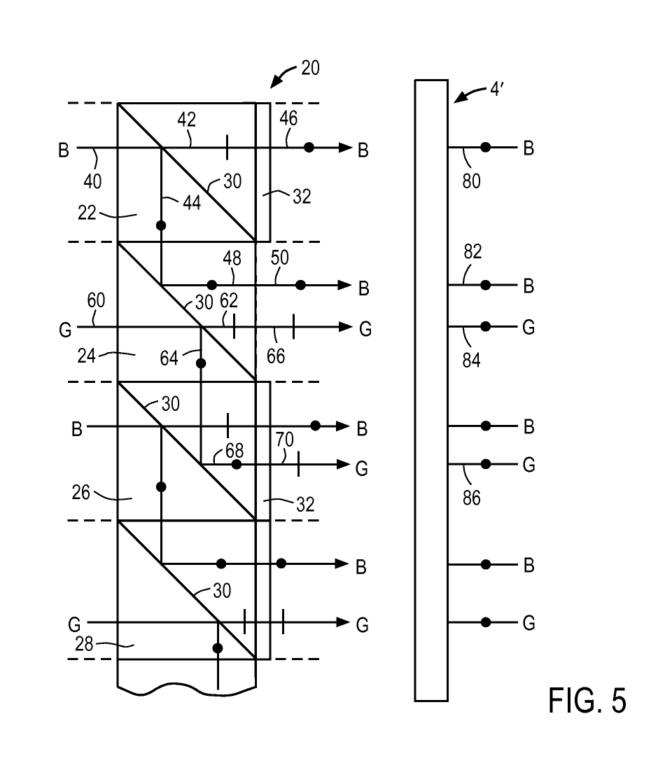

FIG. 5 is a magnified view of a portion of the optical element 20, showing how unpolarized light entering the element is converted into two separate components of polarized light (P polarized light and S polarized light) and how eventually the light exiting the element is all P polarized for the green light and S polarized for the blue light. Although not explicitly shown in FIG. 5, the portion of the optical element 20 associated with other rows of the image of FIG. 2a would convert all of the red light to S polarization, while similarly converting all of the green light to P polarization.

The optical element 20 includes at least four different beamsplitters 22, 24, 26, and 28 stacked together. For ease of understanding, a dashed line is provided along the top and bottom edges of each of the stacked beamsplitters. Each beamsplitter has an internal surface 30 that reflects light of S polarization and passes light of P polarization. Further, alternate beamsplitters 22 and 26 have a half-wave plate 32 and 34, respectively, that converts S polarized light to P polarized light and P polarized light to S polarized light. With reference to FIG. 5, it can be seen that unpolarized blue light 40 enters beamsplitter 22 where it impinges upon surface 30, which passes P polarized blue light 42 and reflects S polarized blue light 44 into the adjacent beamsplitter 24. The P polarized blue light 42 passes through half-wave plate 32 where it is converted to S polarized blue light 46. The S polarized blue light 44 that was reflected toward the adjacent beamsplitter 24 is reflected by surface 30 in the adjacent beamsplitter creating S polarized blue light 48 that passes out of the beamsplitter 24 and is shown as S polarized blue light 50. This same process occurs with beamsplitters 26 and 28 and with other beamsplitters that may be a part of optical element 20. As can be seen, all blue light that exits the element 20 is S polarized.

It can also be seen that unpolarized green light 60 enters beamsplitter 24 where it impinges upon surface 30, which passes P polarized green light 62 and reflects S polarized green light 64 into the adjacent beamsplitter 26. The P polarized green light 62 passes out of the beamsplitter 24 as P polarized green light 66. The S polarized green light 64 that was reflected toward the adjacent beamsplitter 26 is reflected by surface 30 in the adjacent beamsplitter creating S polarized green light 68 that passes through half-wave plate 34 where it is converted to P polarized green light 70. This same process occurs with beamsplitters 28 and its next adjacent beamsplitter and with other beamsplitters that may be a part of optical element 20. As can be seen, all green light that exits the element 20 is P polarized.

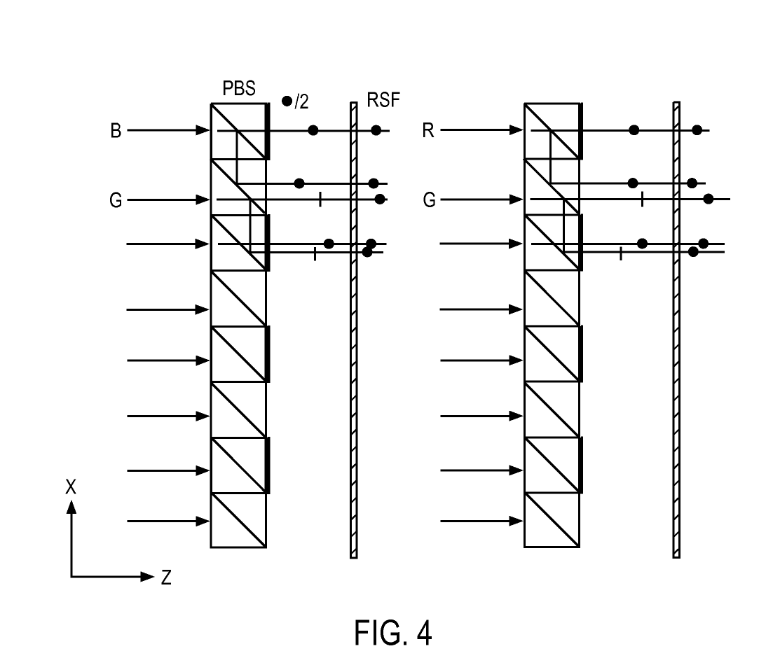

As shown in FIGS. 4 and 5, Retarder Stack Filter (RSF) 4′ after the optical element 20 further modifies the polarization of only the green light such that the polarizations for all colors are at the same orientation usable to the liquid crystal display panel 7. The RSF 4′ has the interesting property that it does not rotate the polarization of all light in the same manner. For example, the optical behavior of the RSF can be engineered to not rotate the polarization of red and blue light, while rotating the polarization of green light. Because of this property, the RSF 4′ converts the P polarized green light 66 and 70 to S polarized green light 84 and 86, but allows the S polarized blue (and red) light 46 and 50 to pass through as S polarized blue (and red) light 80 and 82. Thus, on the downstream side of the RSF 4′, all of the light is S polarized. It should be appreciated that, other than certain losses that will be discussed in further detail below, all of the incoming unpolarized light from the green, blue, and red LEDs has been converted into S polarized light, without discarding half of the light the way a simpler system would. It should be noted that the RSF 4′ could be located anywhere between the optical element 20 and the PBS 6.

Theoretically, efficiency doubling can be achieved. In a realistic system, the following are major factors affecting efficiency. First of all, RGB color patterns at plane 4 are not well defined due to aberrations in collimation lens 3. This may mean a loss of roughly 8% (or −92% efficiency). Second, transmission of P polarized light for optical element 20 is less than 100% (−85%). Third, RSF transmission coefficient is not 100% (−94%). Fourth, there can be misalignment of optical element 20 so a portion of RGB light can shine to the wrong PBS strip. So light efficiency would be 160%=2×92%×(85%/2+0.5)×94% without misalignment. Alignment of different colors relative to each other may not be necessary since RGB are on the same package. This feature can reduce misalignment of optical element 20 compared to other designs where RGB are on separate chip board.

Furthermore, optionally, by appropriate design the pico-projector illumination subsystem can transform the beam cross section to a rectangular one matching the shape and size of the active area of the panel 7, even though the incident beam might be round, or some other shape, and might be a different size than the size of the panel 7. Design techniques for accomplishing these objectives are well known in the art, as described, for example, by Peter Schreiber et al. in their paper “Homogeneous LED-illumination using microlens arrays,” published in Nonimaging Optics and Efficient Illumination Systems II, edited by R. Winston and R. J. Koshel (SPIE, Bellingham, Washington, 2005), Proceedings of SPIE, vol. 5942, pages 59420K1-9.

So-called “polarization conversion systems” (PCS) can be used to overcome efficiency losses that would otherwise arise from the use of unpolarized light sources in systems requiring polarized illumination. Several such PCS implementations are described by F. E. Doany et al, in their article “Projection display throughput: efficiency of optical transmission and light-source collection,” published in the IBM Journal of Research and Development, vol. 42, pp. 387-399 (1998). However, all such polarization conversion systems double the &endue or “extent” of the light source, necessitating faster, larger, and more complex implementations of other optical system elements such as of the PBS and projection lens, separately or in combination with the microdisplay.

As can be appreciated, the system described herein offers several advantages over the prior art systems. First of all, a much greater percentage of the light output by the LEDs is used to illuminate the panel, since all of the light (theoretically) is converted to light of a single linear polarization. This does not occur in prior art systems. Further, the system does not increase the &endue of the projector. Also the effectiveness of a PCS can depend on the width of angles of light received by the PCS. By placing this PCS at a location in the illumination subsystem where the light is collimated, this issue is reduced. Even with realistic limitations in optical element 20, RSF filter, and alignment, a significant efficiency improvement should still be expected. Also, the system improves color uniformity, due to the color overlap in the intermediate LED image plane 4.

RSFs 4′ described herein are commercially available from ColorLink of Tokyo, Japan under the trademark ColorSelect.

The teachings herein should be applicable to any illumination system in which there are at least two different colors in a particular optical channel. For example, there could be a three-color system with two optical channels where one color is provided through one channel and the other two colors are provided through the second channel.

While the embodiments of the invention have been illustrated and described in detail in the drawings and foregoing description, such illustration and description is to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

What is claimed:

1. An illumination subsystem for a pico-projector, comprising:
an array of LEDs, there being at least two LEDs in the array that emit light of a color different from each other, the array including at least one group of LEDs aligned along a straight line, wherein the LEDs in the line include the at least two LEDs of different colors;
a light pipe and lens combination that creates multiple images of the LEDs and at least partially collimates the light from the LEDs;
an optical element receptive of the at least partially collimated light, the element including an array of polarizing beamsplitters (PBSs), wherein the PBSs are configured to each receive an image of only a single one of the LEDs of different color in the line of LEDs, and the element also including a half-wave plate associated with alternate ones of the PBSs, wherein the light of a first color exiting the optical element is of a first linear polarization orientation and the light of a second color exiting the optical element is of a second linear polarization orientation that is orthogonal to the first linear polarization orientation;
a retarder stack film (RSF) that is located downstream of the optical element, the RSF flipping the orientation of any linearly polarized light passing therethrough that is of a first color and not changing the orientation of any linearly polarized light passing therethrough that is of a second color;
wherein once the light of the first color and light of the second color have passed through the RSF, it is all of a single polarization orientation.

2. The subsystem of claim 1, wherein the array of LEDs includes at least three LEDs of different colors.

3. The subsystem of claim 2, wherein the three different colors are red, green, and blue.

4. The subsystem of claim 3, wherein the array is a two-by-two array with a column of two green LEDs and a column with one blue LED and one red LED.

5. The subsystem of claim 1, further comprising a PBS, distinct from the PBS of the optical element, that is located downstream of the optical element.

6. The subsystem of claim 5, wherein the PBS is located downstream of the RSF.

7. The subsystem of claim 5, further comprising a lens that is located downstream of the optical element and upstream of the PBS.

8. The subsystem of claim 1, wherein the optical element receives a two-dimensional image of the LED array, and the image includes rows and columns of differently-colored subimages, where one of a first line includes only green subimages and an adjacent parallel second line includes alternating ones of blue and red subimages, and third and fourth parallel lines that are orthogonal to the first and second lines include alternating ones of green and blue images in the third line and alternating ones of green and red images in the fourth line.

9. The subsystem of claim 8, wherein each of the PBSs in the optical element are elongated so they can each receive an entire one of the first or second lines of subimages.

10. An illumination subsystem for a pico-projector, comprising:
an array of LEDs, there being at least two LEDs in the array that emit light of a color different from each other, the array including at least one group of LEDs aligned along a straight line, such as in a column or a row, wherein the LEDs in the line include the at least two LEDs of different colors;
a collimator to create multiple images of the LEDs and at least partially collimate the light from the LEDs;
an optical element receptive of the at least partially collimated light, the element including an array of polarizing beamsplitters (PBSs), wherein the PBSs are configured to each receive an image of only a single one of the LEDs of different color in the line of LEDs, and the element also including a half-wave plate associated with alternate ones of the PBSs, wherein each PBS passes light that is linearly polarized in a P polarization orientation and reflects light that is linearly polarized in a S polarization orientation, the reflected light being directed to an adjacent PBS where the S polarized light will again be reflected in a direction parallel to the direction that P polarized light that passed through the PBS, further wherein the half-wave plate on the alternate ones of the PBSs flips the orientation of any linearly polarized light passing therethrough so that P polarized light becomes S polarized light and S polarized light becomes P polarized light, further wherein the light of a first color exiting the optical element is of a first polarization orientation and the light of a second color exiting the optical element is of a second polarization orientation that is orthogonal to the first polarization orientation;
a retarder stack film (RSF) that is located downstream of the optical element, the RSF flipping the orientation of any linearly polarized light passing therethrough that is of a first color and not changing the orientation of any linearly polarized light passing therethrough that is of a second color;
wherein once the light of the first color and light of the second color have passed through the RSF, it is all of a single polarization orientation.

11. A method for projecting illumination, comprising:
via a pico-projector,
emitting light in an array of LEDs, there being at least two LEDs in the array that emit light of a color different from each other, the array including at least one group of LEDs aligned along a straight line, wherein the LEDs in the line include the at least two LEDs of different colors;
creating at least one image via a light pipe and lens combination of the LEDs and at least partially collimating the light from the LEDs;
receiving, via an optical element, the at least partially collimated light, the element including an array of polarizing beamsplitters (PBSs), wherein the PBSs are configured to each receive an image of only a single one of the LEDs of different color in the line of LEDs, and the element also including a half-wave plate associated with alternate ones of the PBSs, wherein the light of a first color exiting the optical element is of a first linear polarization orientation and the light of a second color exiting the optical element is of a second linear polarization orientation that is orthogonal to the first linear polarization orientation;
flipping the orientation, via a retarder stack film (RSF) that is located downstream of the optical element, of any linearly polarized light passing therethrough that is of a first color and not changing the orientation of any linearly polarized light passing therethrough that is of a second color;
wherein once the light of the first color and light of the second color have passed through the RSF, it is all of a single polarization orientation.

12. The method of claim 11, wherein the array of LEDs includes at least three LEDs of different colors.

13. The method of claim 12, wherein the three different colors are red, green, and blue.

14. The method of claim 13, wherein the array is a two-by-two array with a column of two green LEDs and a column with one blue LED and one red LED.

15. The method of claim 11, further comprising a PBS, distinct from the PBS of the optical element, that is located downstream of the optical element.

16. The method of claim 15, wherein the PBS is located downstream of the RSF.

17. The method of claim 15, further comprising a lens that is located downstream of the optical element and upstream of the PBS.

18. The method of claim 11, wherein the optical element receives a two-dimensional image of the LED array, and the image includes rows and columns of differently-colored subimages, where one of a first line includes only green subimages and an adjacent parallel second line includes alternating ones of blue and red subimages, and third and fourth parallel lines that are orthogonal to the first and second lines include alternating ones of green and blue images in the third line and alternating ones of green and red images in the fourth line.

19. The method of claim 18, wherein each of the PBSs in the optical element are elongated so they can each receive an entire one of the first or second lines of subimages.
